(19) United States
(12) Patent Application Publication
(10) Pub. No.: US 2024/0411871 A1
(43) Pub. Date: Dec. 12, 2024

(54) SYSTEM ALERT MODELING BASED ON HYPERGRAPH ALERT CLUSTERS

(71) Applicant: Brex Inc., Draper, UT (US)

(72) Inventor: Joshua Liburdi, Santa Rosa, CA (US)

(21) Appl. No.: 18/332,254

(22) Filed: Jun. 9, 2023

(51) Int. Cl. G06F 21/55

(52) U.S. Cl. CPC G06F 21/554

(57) ABSTRACT

There are provided systems and methods for system alert modeling based on hypergraph alert clusters. An entity, such as company or business, may utilize computing services provided by a service provider. Use of computing services provided by the service provider to different entities may generate security alerts when computing events are flagged as risky, fraudulent, malicious, computing attacks, or the like. For better security alert management, search, and alert linking, the service provider may utilize hypergraphs generated from metadata and hashes of data extracted from security alerts, such as a name, payload and the like. The service provider may model the hypergraphs using vertices and hyperedges associated with this metadata and hashes, which then allow for identifying of a threat or security alert scope, retrieval of linked security alerts during investigations, and correlation of security alerts to provide threat-focused alerts.

### TECHNICAL FIELD

The present application generally relates to modeling of security alerts and threats in a computing system and more specifically to utilizing hypergraphs generated from alert metadata to link alerts in clusters for improved threat detection, investigation, and alert generation.

### BACKGROUND

Service provider systems may provide services to customers, such as businesses and companies, through computing systems and networks. These computing systems and networks may also be utilized by internal users, where the systems generate, transmit, and process security event logs, system audit logs, and the like when processing data. As companies and other organizations providing computing services grow in size and breadth of service provision, their internal and external usage of applications, components, and the like require a robust, efficient, and timely security system to detect computing threats, frauds, and attacks, issue security alerts based on occurring events, perform security alert management and threat investigation, and proactively prevent, warn, or detect other conditions that may risk computing system or data breaches, compromise, and the like. For example, data processing through different data processors, microservices, decision services, and/or other computing resources may be malicious attacked and/or compromised, which may risk loss by the service provider. However, manual triage, investigation, and management of real-time alerts may become difficult if not impossible for all generated security alerts, and with large and/or complex computing architectures, threat-focused alert grouping and proactive warning, as well as security investigations, may be time consuming and lead to incorrect, inefficient, or missing results. This creates a computing security system architecture that does not adequately protect the computing systems, components, and services, as well as the corresponding assets, needs, and goals of the service provider when providing such computing services to users.

Therefore, there is a need to address deficiencies with conventional computing security systems and operations used by service providers to detect computing threats and perform investigations into generated computing alerts in large computing infrastructures efficiently, quickly, and precisely.

### BRIEF DESCRIPTION OF THE DRAWINGS

FIG. 1 is a block diagram of a networked system suitable for implementing the processes described herein, according to an embodiment;

FIG. 2 is an exemplary diagram of operations and components used for hypergraph modeling of security alerts for improved security alert management and threat detection, according to an embodiment;

FIGS. 3A and 3B are exemplary diagrams of security alert hypergraphs generated from operations and components discussed in FIG. 2 for security alert modeling, according to an embodiment;

FIG. 4 is an exemplary flowchart for system alert modeling based on hypergraph alert clusters, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for system alert modeling based on hypergraph alert clusters. Systems suitable for practicing methods of the present disclosure are also provided.

In service provider systems, a networked system and provider may include a computing framework and architecture to provide payment gateways, billing platforms, eCommerce platforms, invoicing, and additional services. These systems may include internal and/or external networks of devices and servers, which may be used when providing computing services, platforms, and applications to internal and/or external users. However, with large and complex computing architectures and infrastructures that provide these services, data and computing system security is required by the business, organization, or other service provider providing the computing architecture. For example, a robust, efficient, and proactive security system and team may assist an organization in preventing and/or reducing loss from computing and security threats, attacks, and other malicious or fraudulent conduct, as well as actions and activities by internal and external users that are not malicious or fraudulent but lead to other bad or undesirable outcomes (e.g., revealing authentication or personal information, unwanted spam, unauthorized system or data access, etc.). Such security requirements may be implemented based on laws, rules, regulations, industry and/or organizations standards or goals, and the like. However, with the complexity of modern computing threats and due to large and complicated system architectures (e.g., systems having distributed systems, databases, and networks over many areas and end users), security teams and security computing services, such as detection and response teams, may not have proper data and analysis of causes and links for security alerts. Thus, security operations for triage, investigation, management, and processing of alerts to provide preventative and/or proactive security threat detection, analysis, and alerting is difficult, inefficient, and inaccurate in conventional computing security that fails to adequately understand security alert similarities, links, and clustering from threats and attacks.

In order to solve these issues with conventional security systems, operations, and technology, a service provider may implement a security alert analysis and management system that may utilize hypergraphs to understand and react to relationships between generated security alerts. The alert management system may further provide operations for security alert searching for threats and activities, security investigation analysis, and/or correlation of security alerts and other security data for threat-focused alerts and analysis. To provide these security services for security alerts, the service provider may implement computing services in a serverless computing environment, such as a cloud computing environment (e.g., Amazon Web Services (AWS)). Serverless cloud computing allows a service provider to utilize and request allocation of computing resources dynamically for data processing jobs, such as by selecting, utilizing, or requesting processing of tasks by certain machine clusters, computes, or the like. These resources are specified by the customer, and the customer is charged for and/or provided allocated resources and run time for the data processing task being performed. Cloud computing architectures may provide high scalability and fast response times, and therefore scalable security applications, services, and operations may be provided in such environments for security alert analysis. However, the computing service services and system described herein may also be provided in server-based or other computing systems and/or networks.

In the serverless or other computing environment, the service provider may implement the security system that may receive, detect, and/or obtain data and security signals associated with security alerts and entities in real-time, near real-time, and/or after the event occurs, which may be performed as such alerts enter the service provider's computing systems and/or architecture for analysis. For example, signals may represent security threat behaviors of interest, which may be tied to a security alert or may be associated with another computing activity, communication, interaction, or other data. This may include an external IP address logging on to a service, a process to create a file on a server, and the like. Thus, the signals may be more expansive and include further activities and interactions than just those computing events that trigger or cause a security alert based on security rules, models, neural networks (NNs) and the like. Signals may be associated with computing logs, which may include data and metadata associated with the activity, interaction, or the like from the computing event. Once the signals are received, they may be parsed and/or signal message content may be extracted for data and metadata for the signal. This data may be used to generate hypergraphs, which may utilize identifiers of entities for vertices and the signals between entities (e.g., identified using the hash or other identifier for the event object). Thereafter, hypergraphs may be made storable and searchable, such as using entity identifiers, signal hashes or identifiers, and/or computing event or security alert data and metadata, in order to determine correlations in signals and improve security system operations, such as those for activity scope identification, security investigations, and/or threat-focused alerts.

In this regard, a service provider system may offer computing services, software, online resources and portals, and infrastructure to one or more customer entities (e.g., businesses or companies). The service provider may have a large and/or complex computing architecture that is used to provide these computing services to users. This computing architecture may also provide computing services to internal users of the service provider, such as employees, administrators, coders and developers, data scientists, executives, and other users that may utilize internal systems for communications, data review and processing, and implementation of the service provider's services to customers, end users, and other external entities. Such, implementation of computing services and use of those services may have resulting data that is received, generated, and/or processed by the service provider's computing system and architecture. In turn, to manage these systems and provide for security detection and alerting, a security system may be implemented that detects security issues and events occurring from computing events and their corresponding data logs. As discussed herein, such a security system may also provide alert management to automate processes to suppress and/or deduplicate alerts when recurring, repetitive, and/or ongoing.

In more detail, computing signals may be detected for threats and other behaviors of interest, such as those that may be analyzed by a security team and/or system of a service provider's computing architecture and infrastructure. A service provider may provide a computing infrastructure including a security system, where, as computing events and computing data logs (e.g., network traffic, firewall, etc.) come into the system, security alerts and other events may be generated based on security rules, models, and the like (e.g., rule-based or AI systems, models, and engines that detect computing events indicating risk, attack, malicious or unauthorized conduct, system or data breach or compromise, etc.). For example, an alert may be due to a computing attack, unseen payload or request, malicious user or IP, or other computing event that may trigger a security alert based on a rule-base or artificial intelligence (AI)-based engine (including machine learning (ML) models and engines, neural networks (NN), and the like). The security system may also analyze other types of signals for computing events and logs of interest, such as those that may be associated with, analyzed for, or otherwise correspond to a threat, computing attack, or behavior/activity of interest.

Signals may have corresponding data and metadata, where the metadata may be used for hypergraph generation. For example, metadata may be associated with a computing event and log between different entities identified by Internet protocol (IP) addresses, hostnames, usernames, and the like in a corresponding event object (e.g., a database object or other storable data object, such as a computing log, for the computing event). The metadata for each signal may also include an identifier or hash of an event object that is hashed and/or converted to other hashes or identifiers using a function, algorithm, hash operation, etc., which may be used to uniquely identify each of the signals and event objects for hypergraph comparisons and clustering using hyperedges (e.g., two-dimensional (2D), three-dimensional (3D), or other n-dimensional edge connecting two or more vertices, such as in a cluster in the n-dimensional space). For example, an SHA256 hash of an event object may be included in event metadata for a computing event, log, and/or object.

Thereafter, a signal and hypergraph model system, application, and/or operations may generate one or more hypergraphs based on the metadata. A signal hypergraph may be generated for the received signals and/or multiple hypergraphs may be generated for subsets of the signals based on domain, time, signal of interest or an activity or behavior, set of entities, event processing platform or system entry point, or other user configurable or selectable parameters. Each vertex in the vertices of the hypergraph may represent entities, such as users, organizations, devices, servers, network addresses, endpoints, applications, systems, or the like. Thus, a vertex may be represented by an identifier, hash, vector, or the like for a corresponding entity that uniquely represents the entity in n-dimensional space (e.g., 2D space, such as on X and Y-axes). Further, the vertices may be connected by hyperedges, which may correspond to connections between sets of vertices (e.g., two or more vertices, where cardinality may be preset, based on hyperedge size in the n-dimensional space, user configured, etc.), which may connect an arbitrary number of nodes or vertices in a cluster based on the signals' events. Cluster membership and/or the vertices in hyperedges may be defined by a user selected or procedural manner based on the entities involved in the signal (e.g., entities may be those directly involved, such as through data transmissions, or may be referenced in other event data).

Thereafter, the modeling system may create and store the corresponding hypergraph(s). The hypergraph(s) may be stored as objects in a database based on the corresponding signals, metadata, and/or event hashes, which may allow users to retrieve information from the hypergraphs by searching and/or requesting using a hash, signal information, or the like. Each entity may therefore be represented in the hypergraph with the corresponding signals that the entities are involved in, and each hyperedge may represent the cluster of the entities involved in the corresponding signals. Thus, the hypergraph may allow for viewing and searching of entities and their signals linking entities, which may be used for graph traversal for identification of related or linked entities and/or signals through a number of hops or separation degrees between hyperedges and/or vertices. In this regard, the hypergraph(s) may be used to improve, through faster, more efficient, and more precise searching, graph traversals and explorations, and the like, computing and data security systems, such as those used for computing security threat detection, identification, and assessment.

For example, the hypergraphs may be used with the security system for identifying a scope of an activity and/or behavior of interest to the security system. A signal may be retrieved, such as by an event object hash or the like, and those corresponding entities, as well as the other signals those entities are involved with (and further, the entities involved in those signals, and so on for further graph traversal and/or exploration). This may allow for identification of a number of events associated with specific threat behaviors. Additionally, signals may be retrieved by their hash in order to aid in and speed up the processes and searches for security investigations. The hashes for event signals may be used and searched when a security alert and/or other computing event is being investigated (e.g., results in a computing attack, system or data compromise, etc.), which allows for retrieval of linked entities and other signals. The security system may also use the hypergraphs in order to correlate signals based on hashes and entities to create threat-focused alerts. Thus, by searching and linking signals and entities into smaller clusters based on their related interactions, a threat-focused alert to specific entities and/or based of certain signals for behaviors of interest, may be generated.

Such a computing security and threat detection system may provide automated operations in computing systems and architectures for organizing and clustering entities and signals related to computing events into hypergraphs. The hypergraphs may then be stored and made searchable using hashes or other identifiers for signals and event objects for the computing events. This allows for fast, precise, and efficient modeling and searching system of computing alerts, signals, and events, which may provide improved computing security systems and operations. As such, computing systems may be provided with more efficient, faster, and more reliable data security.

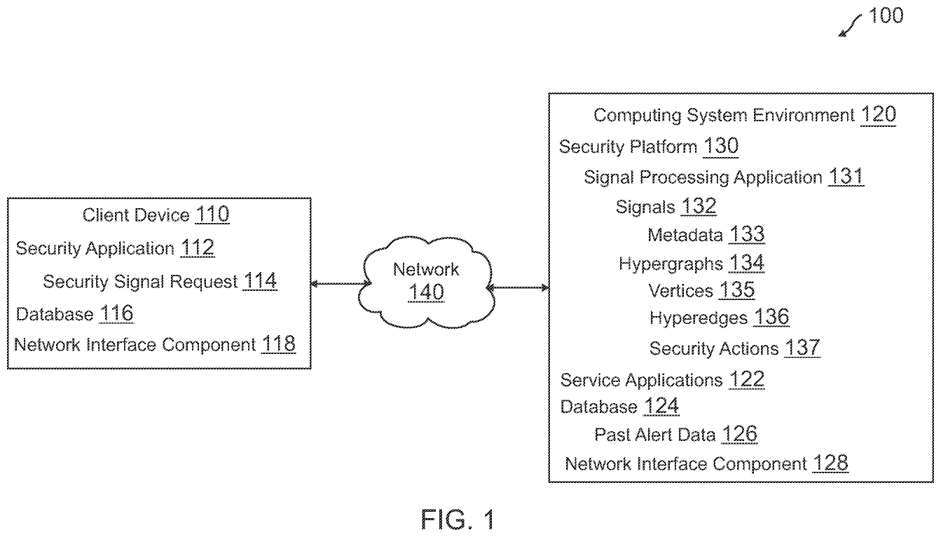

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways, and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a client device 110 and a computing system environment 120 in communication over a network 140. A user (not shown) may correspond to an employee, administrator, developer, contractor, or other suitable person of a company (not shown and generally referred to herein as an “employee” or “user” associated with such a system) associated with computing system environment 120. The employee or other user may utilize the services provided by computing system environment 120 from a service provider through client device 110, including modeling signals and/or security alerts associated with computing events in hypergraphs. Computing system environment 120 may process data with client device 110, such as during computing system use, login, communications, authentication, underwriting, account generation or usage, electronic transaction processing, expense management, or the like. In this regard, computing system environment 120 may provide security operations and signal hypergraph modeling for security threat detection, identification, prevention, and/or assessment through hypergraphs of computing event signals.

Client device 110 and computing system environment 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be utilized by an employee, security team member, security agent or expert, contractor, affiliate, or owner of an entity or company that employs one or more users, for example, to utilize and/or interact with computing services provided by computing system environment 120. For example, in one embodiment, client device 110 may be implemented as a personal computer (PC), telephonic device, a smart phone, laptop/tablet computer, wristwatch with appropriate computer hardware resources, eyeglasses with appropriate computer hardware (e.g., GOOGLE GLASS ®), other type of wearable computing device, implantable communication devices, and/or other types of computing devices capable of transmitting and/or receiving data. In this regard, client device 110 includes one or more processing applications which may be configured to interact with computing system environment 120. Although only one system endpoint is shown, a plurality of communication devices may function similarly.

Client device 110 of FIG. 1 includes a security application 112, a database 116, and a network interface component 118. Security application 112 may correspond to executable processes, procedures, and/or applications with associated hardware. In other embodiments, client device 110 may include additional or different modules having specialized hardware and/or software as required.

Security application 112 may be implemented as specialized hardware and/or software utilized by client device 110 to access and/or utilize services associated with computing system environment 120, such as internal and/or external users (e.g., security team members, administrators, specialists, investigators, etc.) when engaging and/or maintaining computing services provided by a corresponding service provider. Such computing services of the service provider may be used for underwriting for credit, onboarding and/or management of an account, electronic transaction processing, and/or usage of other services. Further, security application 112 may be used to provide computing and data security services and operations to users, including those for hypergraph generation and use, such as for hypergraph searching, traversal, and/or exploration with security signals, events, or alerts. As such, security application 112 may be used to receive security signal request 114, such as to search and/or view hypergraph data, links, and relationships between events and signals for computing events, logs, or behaviors of interest.

These computing services may be provided by a service provider associated with computing system environment 120, which may be provided to an entity (e.g., an organization, business, company, or the like including startup companies that may require credit services). For example, a user associated with the entity may utilize such services to receive data and/or request processing for data from computing system environment 120. Security application 112 may be used to receive, view, manage, investigate, and/or otherwise process data for signals corresponding to computing events and entities involved in those events. Signals may correspond to a behavior of interest to a security team and/or system associated with computing system environment 120, which may be generated by computing events and corresponding logs occurring from internal and/or external use of the computing services provided by computing system environment 120. In this regard, security application 112 may correspond to software, hardware, and data utilized by a user associated with client device 110 to view, query, search, and/or explore hypergraphs modeled from these signals and entities for various security services and operations. Security signal request 114 may correspond to an input, query, and/or search using client device 110 for one or more signals, which may be identified by a hash or identifier for a computing event or log, an entity identifier, or the like, for other signals and/or entities linked or related in a hypergraph. Thus, security signal request 114 may be based on a computing event that occurred and was logged for the corresponding signal. Security signal request 114 may be provided to client device 110 for search, traversal, and/or exploration of a corresponding hypergraph by querying a database using the hash, entity identifier, or the like. Such signals may be associated with financial processing, underwriting, and the like. In other embodiments, the computing services provided by computing system environment 120 and/or associated with security signal request 114 may further include email and messaging, social networking, microblogging, media sharing and/or viewing, streaming, and/or other data processing services.

In various embodiments, security application 112 may include a general browser application configured to retrieve, present, and communicate information over the Internet (e.g., utilize resources on the World Wide Web) or a private network. For example, security application 112 may correspond to a web browser, which may send and receive information over network 140, including retrieving website information, presenting the website information to the user, and/or communicating information to the website, including payment information. However, in other embodiments, security application 112 may include a dedicated software application of computing system environment 120 or other entity. Although security application 112 is discussed with regard to generating and using hypergraphs of signals for computing and digital security, security application 112 may also be configured and/or utilized to assist in onboarding for accounts, establishing and maintaining the accounts, engaging in electronic transaction processing, and/or otherwise engaging in computing services provided by computing system environment 120.

Client device 110 may further include database 116 stored in a transitory and/or non-transitory memory of client device 110, which may store various applications and data and be utilized during execution of various modules of client device 110. Database 116 may include, for example, identifiers such as operating system registry entries, cookies associated with security application 112, identifiers associated with hardware of client device 110, or other appropriate identifiers, such as identifiers, tokens, and/or fingerprints for devices, applications, accounts, and/or users. Database 116 may further include security signal request 114 and the like, which may be delivered, automatically or on command, to computing system environment 120 for hypergraph use with signal assessment.

Client device 110 includes at least one network interface component 118 adapted to communicate with computing system environment 120 and/or another device or server. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices.

Computing system environment 120 may be maintained, for example, by an online service provider, which may provide services for account creation and onboarding, credit or loan underwriting services, payment and transaction processing services, expense management services to companies, businesses, and other entities, and/or other computing services, which may include data, computing, and digital security services associated with providing such computing services. In this regard, computing system environment 120 includes one or more processing applications which may be configured to interact with client device 110 and other devices or servers to facilitate provision of data, computing, and digital security services. In one example, computing system environment 120 may be provided by BREX®, Inc. of San Francisco, CA, USA. However, in other embodiments, computing system environment 120 may be maintained by or include other types of credit providers, financial services providers, and/or other service providers, which may provide services to users and entities.

Computing system environment 120 of FIG. 1 includes service applications 122, a security platform 130, a database 124, and a network interface component 128. Service applications 122 and security platform 130 may correspond to executable processes, procedures, and/or applications with associated hardware. In other embodiments, computing system environment 120 may include additional or different modules having specialized hardware and/or software as required.

Service applications 122 may correspond to specialized hardware and/or software to allow entities (e.g., the entity associated with client device 110) to provide computing services to external users, entities, and the like, which may include account services, provide credit or loan extensions via underwriting models and/or services, process payments and transactions using one or more payment cards or other financial instruments, provide expense management systems, and/or provide additional services. Such services provided by service application 122 may also be provided, maintained, and supported by internal systems, computing infrastructure, applications, and internal users or teams (including security teams) for computing system environment 120. Thus, service applications 122 may correspond to one or more services provided by, in, and/or is associated with computing system environment 120 to an entity, which may include use, maintenance, and/or engagement by internal users, teams, and entities (as well as external third-party users, contractors, systems, and the like). In some embodiments, the services may include account and/or credit services where service applications 122 may include underwriting systems and models, which may extend credit or other loans based on parameters for an entity. Using the accounts and/or credit, electronic transaction processing services may also be provided to users and entities via service applications 122. In further embodiments, service applications 122 may provide expense management services, such as those that may integrate with an entity's expense, payroll, human resources, business panning, and the like to provide enterprise resource planning (ERP) services. Service applications 122 may be provided in different server or serverless computing environment.

In some embodiments, the services may be used to receive payment instruments associated with a bank account, extended credit, and/or funding of the company, such as one or more company credit cards. In this regard, an entity may first establish an account with service applications 122 by providing company or entity data and onboarding through service applications 122. The company or entity data may include IRS EIN information and/or other information that may be utilized to verify a company, business, organization, or other entity. Such information may further include bank account and funding information, such as verified funding from investors, available funds in a bank or financial account, and the like. If qualified based on policies, rules, and/or models, computing system environment 120 may onboard the entity associated with client device 110 for services provided by computing system environment 120. This may include credit extended to the entity based on entity financial data. In this regard, computing system environment 120 and/or another issuing entity may provide a payment instrument that is managed by service applications 122. For example, computing system environment 120 may issue one or more credit cards for employees of the entity, which may correspond to a real or virtual credit card or other types of payment instruments and instrument identifiers that may be used for company payments.

During use of service applications 122, one or more computing events may trigger or cause generation of security alerts for an issue, attack, error, or other computing activity that requires alerting and/or resolution. Such, security alerts may be tracked by security platform 130. In further embodiments, security platform 130 may also track other signals generated from use of service applications 122 by internal and/or external users, devices, servers, endpoints, and the like. Signals may be associated with a computing event and may cause a security alert or be tracked and monitored based on a behavior of interest (e.g., without triggering or causing a security alert). Signals may be associated with a computing log or other event log, event object, or the like. Where such data may include event, traffic, and/or security logs, service applications 122 may receive or access such logs from corresponding events that occur with the service provider, and signals may be tracked for use by one or more endpoints (e.g., client device 110 and/or other devices, servers, address, identifiers, or the like used by users to receive, view, and/or act on such signals when modeled in hypergraphs). Signals and signal assessment through hypergraphs may be done based on stored and accessible data and/or in real-time or near real-time when the computing event occurs.

Service applications 122 may further be used to provide financial services and electronic transaction processing computing services to users, such as to process transactions. In this regard, service applications 122 may utilize one or more payment networks to process a transaction, such as by issuing a payment over a payment network and/or by requesting payment by a credit issuing bank or institution to the merchant and/or acquiring bank or institution. In other embodiments, the credit card and payment network may be managed by another entity and/or payment network, where an integration by computing system environment 120 with the network may allow for acquisition of transaction data by service applications 122 in real-time or substantially in real-time. Service applications 122 may further issue transaction histories for security signal request 114 and provide accounting and recordation of transaction data, such as with the ERP resources provided by service applications 122.

Service applications 122 may include computing services that correspond to one or more data processing stacks, components, processors, microservices, and/or decision services of a service provider to provide these services utilized by client device 110 and/or other devices or servers. The computing services may correspond to different computing systems and/or processors of the service provider that may provide a data processing service and/or operation for data that is delivered to client device 110. For example, the computing services may be associated with login, authentication, transaction processing, verification, risk and/or fraud detection, payment networks and/or ACHs, and the like. Use of computing services by internal and/or external users may create logs, such as security logs and/or system audit logs. Thus, security platform 130 may be invoked in order to process received and/or generated logs and other data that is delivered to client device 110 and/or utilized by client device 110 for assessment of corresponding signals through hypergraphs.

Security platform 130 may correspond to specialized hardware and/or software to allow end users, security users and/or teams, administrators, engineers, compliance officers, security contractors, and other users associated with computing system environment 120 to receive, process, and model signals from computing events and logs of interest that are generated during use of service applications 122 through different servers, devices, systems, databases, or the like. In some embodiments, security alert management may include further hypergraph retrieval, search, traversal, and/or other exploration based on queries and requests, such as security signal request 114 from client device 110. Security platform 130 may execute a signal processing application 131 to process signals 132 for behaviors and interactions of interest from computing events and/or corresponding event logs, which may be designated by the system or caused by security alerts and the like triggered or monitored from security rules, models, NNs, or the like to detect a security condition or event (e.g., fraud, data breach, computing attack, malicious or suspicious conduct, etc.). Signals 132 may include corresponding data and metadata 133 for the computing event, event object, and/or log that is used to record data for the signal. In this regard, signals 132 may include, be parsed for and have extracted, or otherwise processed for metadata 133 including a hash (e.g., an SHA256 hash) of an event object or other identifier uniquely identifying the event and data for the event corresponding to each of signals 132. Metadata 133 may further include identifiers or other information identifying entities associated with the event. In some embodiments, signal processing application 131 may correspond to a microservice that may correspond to a combination of standalone and integrated services.

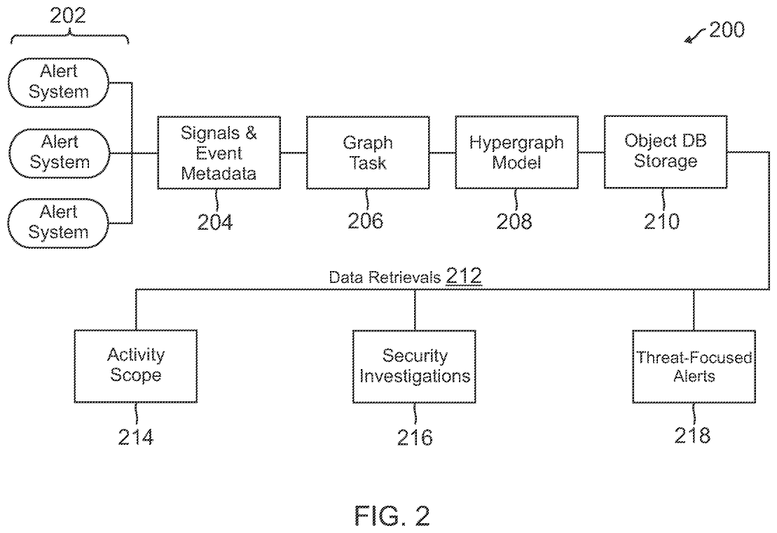

Thereafter, hypergraphs 134 may be generated using metadata 133 and/or other available data for signals 132. In this regard, vertices 135 may be generated for entities, such as based on identifiers or other data uniquely identifying entities involved in a signal from signals 132. Vertices 135 may be generated for different entities and then linked or clustered using hyperedges 136 representing edges that may include any number of vertices (e.g., may link two or more vertices, not just two vertices, where cardinality of the number of vertices may be arbitrary or defined by various parameters or conditions of the corresponding events). Hyperedges 136 may be generated based on the signals corresponding to the events and including the entities represented by vertices 135. Thereafter, hypergraphs 134 may be used for security purposes, such as to identify scope of an activity, perform security investigations, and/or correlate signals and entities based on hashes for search and threat-focused alerts. The operations and features of security platform 130 for performing hypergraph generation and use during security events, investigations, alerts, and other operations are described in further detail with regard to FIGS. 2-4 below.

Additionally, computing system environment 120 includes database 124. As previously discussed, the user and/or entity may establish one or more accounts with computing system environment 120. Account data stored by database 124 may include customer credit accounts and other entity information, such as name, address, entity organization and/or formational information (e.g., incorporation, tax, and/or good standing documents), funding information (e.g., bank balances and/or incoming funding), additional user financial information, and/or other desired entity data. Further, database 124 may also include past alert data 126 for signals corresponding to events, activities, interactions, and/or behaviors of interest, which may include those causing security alerts through a security system of computing system environment 120. As such, database 124 may store past alert data 126 including one or more event objects, data tables, or structures including metadata and the like for corresponding events, which may including entity identifiers or identifying information and hashes of corresponding event objects or the like. Using past alert data 126, hypergraphs 134 may be generated, which may further be stored with past alert data 126 or searchable using the data from past alert data 126, such as hashes of event objects and/or identifiers.

In various embodiments, computing system environment 120 includes at least one network interface component 128 adapted to communicate with client device 110 and/or other devices or servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices.

In various embodiments, one or more of the devices, systems, and/or components of system 100 may access and/or utilize one or more computing systems or architectures of a banking or financial institution that may provide data processed by computing system environment 120. For example, the financial institutions may include a computing system and/or network utilized for funding balances within accounts, such as bank and/or financial accounts of funds available to business entities. The financial institution(s) may further provide resolution of payment requests and electronic transaction processing, which may be governed by permissions (e.g., acceptances and denials) of payment requests for transaction processing by computing system environment 120. In this regard, the financial institution(s) may provide one or more accounts that include balances available to an entity, such as bank accounts and other accounts that include assets of the business entity. A financial institution may correspond to an acquiring and/or issuing bank or entity that may hold accounts for users and/or assist in resolving payments.

Network 140 may be implemented as a single network or a combination of multiple networks. For example, in various embodiments, network 140 may include the Internet or one or more intranets, landline networks, wireless networks, and/or other appropriate types of networks. Network 140 may correspond to small scale communication networks, such as a private or local area network, or a larger scale network, such as a wide area network or the Internet, accessible by the various components of system 100.

FIG. 2 is an exemplary diagram 200 of operations and components used for hypergraph modeling of security alerts for improved security alert management and threat detection, according to an embodiment. Diagram 200 of FIG. 2 includes a representation of signal processing operations for security systems by computing system environment 120 using security platform 130 discussed in reference to system 100 of FIG. 1. In this regard, diagram 200 may be executed by security platform 130 in a computing environment that uses signals associated with computing events in order to generate hypergraphs relating different entities through hyperedges of their shared signals.

In diagram 200, an overview is shown of a system that processes signals for behaviors of interest in order to generate the aforementioned hypergraphs to improve computing and data security operations and systems implements for a computing architecture of a service provider. A signal detection system 202 is initially invoked and utilized with computing events and logs in order to detect, monitor, and/or record data for the signals of interest, which may correspond to an event, event log, and/or event object having data and metadata. Data and metadata may be ingested and processed, which may include generating hashes or other identifiers uniquely identifying an event object or other data corresponding to the computing event and signal. The metadata may include at least entities involved in the signal and a hash (e.g., an SHA256 generated hash) of an event object or the like generated from the event and/or signal. Signal detection system 202 is shown as having three alert systems for different detection components, such as different platforms, applications, and/or available data processing operations used by different users and/or entities with the corresponding service provider.

Signals and event metadata 204 may be received, accessed, or otherwise obtained by security computing systems and operations of the service provider implementing signal detection system 202. Using signal and event metadata 204, graph task 206 may be scheduled and/or executed. Graph task 206 may correspond to graphing and/or modeling operations that are used to generate hypergraphs in an n-dimensional space (e.g., 2D, 3D, or other space that may be used to represent vertices, vectors, or the like for entities, signals, and other data of interest to graph and represent). When using the graphing and modeling operations, vertices may represent entities, such as by unique identifiers, vector representations of the entities name, description, or other data, or a hash of similar entity data. Linking, grouping, or clustering the vertices may be performed by hyperedges representing signals between or involving the entities, which may be used to link and/or represent each of the signals by clustering those entities in the metadata for the signals. The hyperedges may be of any degree or cardinality depending on the number of entities associated with the signals, and the membership or linking by a hyperedge may be set by the user based on where in the data/metadata or why the entity is associated with the corresponding signal. Hyperedges may also be represented or described by their event object hash, such as an SHA256 hash, of their corresponding event object for the signal so that searching and data retrieval, or other graph traversal and exploration, may be done using such hashes.

A hypergraph model 208 may then be output by the operations executing diagram 200. Hypergraph model 208 may correspond to the hypergraph representation of the vertices and edges from the metadata (e.g., entities and event object hashes) for the signals from signals and event metadata 204. Hypergraph model 208 may be stored as a hypergraph database object, which may include data for the vertices for the entities and the hyperedges for the signals (or other data representing the signals, such as event hashes from event object data). Diagram 200 may continue to object database storage 210 to store hypergraph model 208 as a database object that is searchable and/or usable for computing and data security operations, investigations, and the like.

Diagram 200 may continue to data retrievals 212 from object database storage 210, which may utilize identifiers or other information used to search for and identify entities in hypergraph model 208 and/or hashes (e.g., of event object data) or other information associated with signals for search by signals and identifying corresponding hyperedges. In this regard, activity scope 214 may retrieve signals based on name to identify a scope of an activity, such as the number of events associated with a specific threat behavior. For security investigations, signals may be retrieved based on hash in order to aid in the speed, efficiency, and precision of security investigations and accurately identify a signal or computing event that is associated with a security event and/or investigation. Further, threat-focused alerts 218 may be generated by correlating signals based on their hash and entities. Threat-focused alerts 218 may be generated for these correlated signals to alert security teams and/or entities of threats specifically targeting entities and/or using certain signals or behaviors.

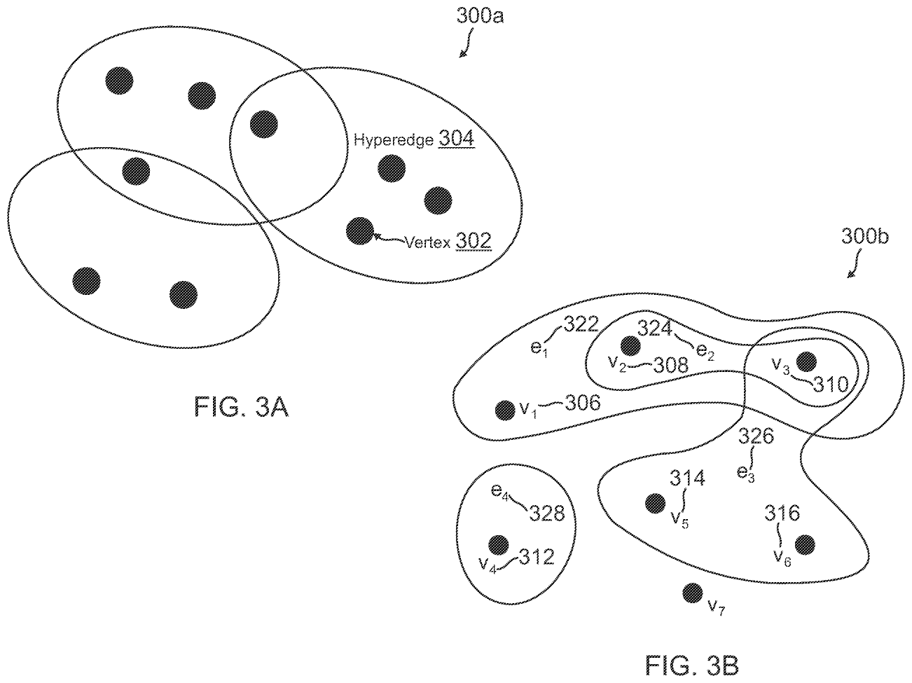

FIGS. 3A and 3B are exemplary diagrams 300a and 300b of security alert hypergraphs generated from operations and components discussed in FIG. 2 for security alert modeling, according to an embodiment. Diagrams 300a and 300b includes hypergraphs generated from signals and their corresponding metadata, such as by computing system environment 120 in system 100 of FIG. 1, which may be used to improve computing and data security systems. Thus, the hypergraphs in diagrams 300a and 300b may be generated, stored, and utilized by security platform 130 in computing system environment 120 of system 100.

In diagram 300a, a hypergraph is shown where vertices are plotted in a 2D space and linked into groups, clusters, or otherwise by hyperedges so that hyperedges may include more than two vertices and may share vertices with other hyperedges. In this regard, a vertex 302 may correspond to an entity, such as by representing the entity through a unique identifier, hash, or the like. Unique identifiers for entities may include those generated from a name, username, host name, IP address, unique identifier, metadata identification information of the entity, and the like, and then plotted in diagram 300a as vertex 302.

A hyperedge 304 then is generated to include, link, or otherwise cluster vertex 302 with other vertices for entities corresponding to a specific signal, such as a computing alert, behavior of interest, or other computing event and/or log. Hyperedge 304 may have a corresponding hash or identifier for searching and identification of hyperedge 304. For example, signal hashes and/or identifiers may be generated using an event object, payload data, metadata, and/or other information associated with the signal. As shown in diagram 300a, vertex 302 is included in the group of vertices with hyperedge 304. The vertices in hyperedges 304 further include one shared with another hyperedges, which in turn has multiple other vertices. With further graph traversal or exploration of diagram 300a, those vertices further include one shared with another hyperedge including further vertices. This then shows how hyperedges may be used to show relationships between different entities and signals, which is further described in diagram 300b below.

In the hypergraph model of diagram 300b, vertices (all labeled points v n) correspond to entities and hyperedges (all labeled clusters or groups e n) correspond to the signals related to those entities. The relationship between entities and signals may be correlated by the SHA256 hash or other hash from a hashing algorithm or function of the event object. In this regard, vertex 306 may correspond to an entity involved in one signal, vertex 308 may correspond to an entity involved in two signals, and vertex 310 may correspond to an entity involved in three signals; vertices 306, 308, and 310 may each be observed within one signal corresponding to a hyperedge 322, while vertices 308 and 310 may be within the signal for hyperedge 322 and another signal for a hyperedge 324, and vertex 310 within hyperedges 322 and 324, as well as a third signal for a hyperedge 326. Hyperedge 326 also contains vertices 314 and 316, while a hyperedge 328 alone contains a vertex 312 that may correspond to a signal involving only that entity for vertex 312. Additionally in diagram 300b, an entity not included in any signals is shown without a corresponding hyperedge to denote that the entity was not involved in a signal for a behavior of interest.

Thus, diagram 300b shows a hypergraph that may allow users to view relationships and links between the entities corresponding to vertices 306, 308, 310, 312, 314, and 316, such as by viewing hyperedges 322, 324, 326, and 328 that form groups or clusters of such vertices from signal association and/or involvement. For the hypergraph in diagram 300b, signals and metadata may be stored as an object in a database (e.g., for {“signal”:“foo”, “event_hash”:“e3b02427ae41e1b78525”}). This allows users and other entities involved in security operations to retrieve the information by either hash or signal and then apply the information and/or hypergraph in different ways. In this regard, signals may be retrieved based on name to identify a scope of activity (e.g., number of events associated with specific threat behavior).

In this regard, hyperedge 324 may show a signal for a threat behavior that involves vertices 308 and 310 and is included in hyperedge 322, thereby affecting or potentially involving vertex 306 or further linking to hyperedge 326 by vertex 310's inclusion in such hyperedge. Signals may also be retrieved based on hash as an aid to speed up security investigations, such as by querying the hash of one of hyperedges 322, 324, 326, and/or 328 to retrieve corresponding vertices and therefore entities, as well as traversing to other hyperedges and vertices for further investigation. The hypergraph in diagram 300b may also allow for signals tp be correlated based on hash and entity to create threat-focused alerts, such as by creating alerts for specific one of hyperedges 322, 324, 326, and/or 328, as well as notifying entities corresponding to vertices in such hyperedges based on a threat for the behavior of interest corresponding to that signal and hyperedge.

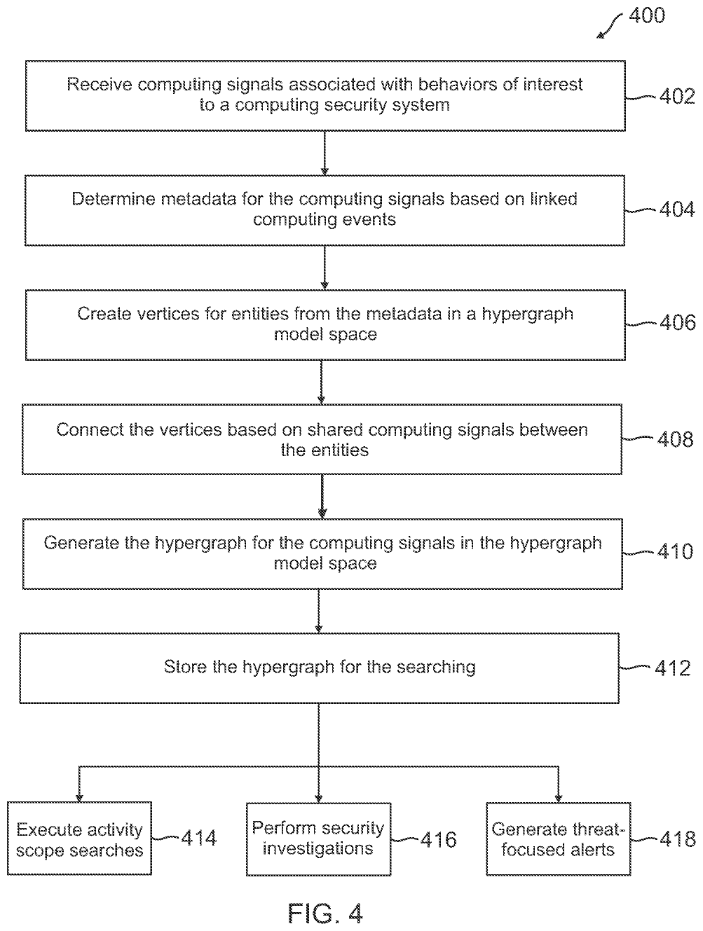

FIG. 4 is an exemplary flowchart 400 for system alert modeling based on hypergraph alert clusters, according to an embodiment. Note that one or more steps, processes, and methods of flowchart 400 described herein may be omitted, performed in a different sequence, or combined as desired or appropriate.

At step 402 of flowchart 400, computing signals associated with behavior of interest to a computing security system are received. A computing signal, such as one associated with a behavior of interest, may be generated from data associated with a data processing flow, platform, application, activity, or the like that may be monitored or trigger an alert or other operation to track, record, and/or analyze the computing event, log, and the like. For example, data for an authentication, login, or the like may be analyzed for security breaches, attacks, credential stuffing, or the like. In this regard, the data may correspond to logs and/or log files having recorded events and the like. Logs may include security event logs, system audit logs, and the like that are used for system security and security auditing by different endpoints.

At step 404, metadata for the computing signals are determined based on linked computing events. The computing event for the signal may have a corresponding event log and/or event object, storable in a database and used for calculating or generating a hash using a hashing algorithm, having information associated with the event, systems, users, and/or activities involved in signal. Such data may be parsed to determine the contents of the data and metadata, and information, such as involved entities and an event object (as well as event object hash) may be determined. For example, the metadata may include an entity name, an entity identifier, a username, a host name, or an IP address from the computing events, as well as a hash for each of the computing events calculated using a corresponding event log.

At step 406, vertices are created, for entities from the metadata, in a hypergraph model space. Based on the entities involved in each signal, vertices may be plotted or otherwise generated and provided in an n-dimensional space, such as a 2D graph space, for a corresponding hypergraph. At step 408, the vertices are connected based on shared computing signals between the entities. Connecting the vertices may include generating hyperedges that include two or more vertices based on the corresponding entities for those vertices being involved in the same signal. Thus, each of the vertices may be involved in one or more signals, where the interactions and signal involvements may be shown though hyperedge membership, although other entities being monitored may also be provided in the hypergraph without connecting hyperedges if no signals are found.

At step 410, a hypergraph for the computing signal in the hypergraph model space is generated. The hypergraph may correspond to a general directed graph where vertices are linked by edges. However, instead of each edge involving only two vertices, hyperedges may involve any number of vertices, including single vertices or more than two vertices. As such, vertices may share membership in hyperedges with multiple different vertices (of an arbitrary cardinality) and/or may be linked in multiple hyperedges as groups or clusters. The hyperedge may therefore correspond to one or more relationships between two or more entities, where the relationship(s) are correlated with a hash of an event object for the corresponding computing events. The hypergraph allows for graph traversal and exploration to determine linked or associated signals and entities based on behaviors of interest. At step 412, the hypergraph is stored for searching. This may include storing a hypergraph data object having identifiers for the signals and event hashes associated with the computing events for the metadata.

Flowchart 400 may then proceed to one or more of steps 414, 416, and/or 418. For example, at step 414, activity scope searches are executed. A search operation may be performed where the search operation is associated with an identification of a scope of a computing activity associated with at least a portion of the signals by searching using a name of the signal and/or entity. At step 416, security investigations are performed.

Search operations for security investigations may include searching and/or querying by a hash of the signal, where the search requests identification of vertices related to the hash based on at least one hyperedge. At step 418, threat-focused alerts are generated. With threat-focused alerts, alerts may be generated by searching for hyperedges and/or vertices and creating a threat-focused alert for a subset of the events linked by one or more hyperedges.

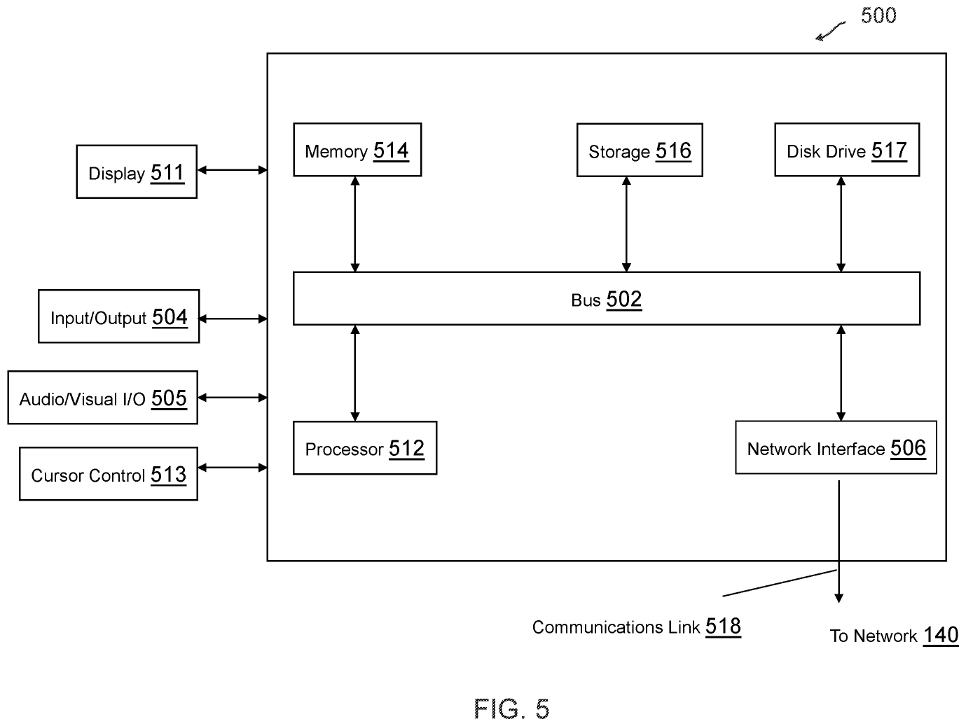

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with network 140. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving a plurality of signals associated with security behaviors of interest, wherein the plurality of signals correspond to a plurality of computing events occurring with a computing architecture corresponding to a service provider;
determining metadata for each of the plurality of signals based on a corresponding one of the plurality of computing events;
generating a plurality of vertices for entities corresponding to the plurality of signals in an n-dimensional space for a hypergraph;
connecting the plurality of vertices by at least one hyperedge in the n-dimensional space based on each of the plurality of signals shared by two or more of the entities;
generating the hypergraph based on the plurality of vertices and the at least one hyperedge; and
executing a search operation associated with a security threat of interest for one or more of the security behaviors of interest based on the hypergraph, wherein the search operation is based on a query identifying data associated at least one of the plurality of computing events, the metadata, or the entities.

2. The system of claim 1, wherein the operations further comprise:
generating a hypergraph data object for the hypergraph, wherein the hypergraph data object comprises identifiers for the plurality of signals and event hashes associated with the plurality of computing events for the metadata; and
storing the hypergraph data object in a searchable database accessible by a computing security system.

3. The system of claim 2, wherein the operations further comprise:
providing a search system for retrievals of security search result data from the hypergraph data object using a search option including at least one of the identifiers or the event hashes.

4. The system of claim 1, wherein the at least one hyperedge comprises at least one relationship between the two or more entities, and wherein each of the at least one relationship is correlated with a hash of an event object for each of the plurality of computing events.

5. The system of claim 1, wherein the search operation is associated with an identification of a scope of a computing activity associated with at least a portion of the plurality of signals.

6. The system of claim 1, wherein the search operation utilizes a hash associated with one of the plurality of computing events for a security investigation, and wherein the search operation requests identification of vertices related to the hash based on the at least one hyperedge.

7. The system of claim 1, wherein the search operation is associated with a creation of a threat-focused alert for a subset of the plurality of computing events linked by one of the at least one hyperedge.

8. The system of claim 1, wherein the metadata comprises at least one of an entity name, an entity identifier, a username, a host name, or an IP address from each of the plurality of computing events, and wherein the metadata further comprises a hash for each of the plurality of computing events calculated using a corresponding event log.

9. A method comprising:
receiving a plurality of signals associated with security behaviors of interest, wherein the plurality of signals correspond to a plurality of computing events occurring with a computing architecture corresponding to a service provider;
determining metadata for each of the plurality of signals based on a corresponding one of the plurality of computing events;
generating a plurality of vertices for entities corresponding to the plurality of signals in an n-dimensional space;
connecting the plurality of vertices by at least one hyperedge in the n-dimensional space based on each of the plurality of signals shared by two or more of the entities;
generating a hypergraph based on the plurality of vertices and the at least one hyperedge; and
executing a search operation associated with a security threat of interest for one or more of the security behaviors of interest based on the hypergraph, wherein the search operation is based on a query identifying data associated at least one of the plurality of computing events, the metadata, or the entities.

10. The method of claim 9, further comprising:
generating a hypergraph data object for the hypergraph, wherein the hypergraph data object comprises identifiers for the plurality of signals and event hashes associated with the plurality of computing events for the metadata; and
storing the hypergraph data object in a searchable database accessible by a computing security system.

11. The method of claim 10, further comprising:
providing a search system for retrievals of security search result data from the hypergraph data object using a search option including at least one of the identifiers or the event hashes.

12. The method of claim 9, wherein the at least one hyperedge comprises at least one relationship between the two or more entities, and wherein each of the at least one relationship is correlated with a hash of an event object for each of the plurality of computing events.

13. The method of claim 9, wherein the search operation is associated with an identification of a scope of a computing activity associated with at least a portion of the plurality of signals.

14. The method of claim 9, wherein the search operation utilizes a hash associated with one of the plurality of computing events for a security investigation, and wherein the search operation requests identification of vertices related to the hash based on the at least one hyperedge.

15. The method of claim 9, wherein the search operation is associated with a creation of a threat-focused alert for a subset of the plurality of computing events linked by one of the at least one hyperedge.

16. The method of claim 9, wherein the metadata comprises at least one of an entity name, an entity identifier, a username, a host name, or an IP address from each of the plurality of computing events, and wherein the metadata further comprises a hash for each of the plurality of computing events calculated using a corresponding event log.

17. A non-transitory machine-readable medium having stored thereon machine-readable instructions executable to cause a machine to perform operations comprising:
receiving a plurality of signals associated with security behaviors, wherein the plurality of signals correspond to a plurality of computing events occurring with a computing architecture corresponding to a service provider;
determining metadata for each of the plurality of signals based on a corresponding one of the plurality of computing events;
generating a plurality of vertices for entities corresponding to the plurality of signals in an n-dimensional space;
connecting the plurality of vertices by at least one hyperedge in the n-dimensional space based on each of the plurality of signals shared by two or more of the entities;
generating a hypergraph based on the plurality of vertices and the at least one hyperedge; and
executing a search operation associated with a security threat for one or more of the security behaviors based on the hypergraph, wherein the search operation is based on a query identifying data associated at least one of the plurality of computing events, the metadata, or the entities.

18. The non-transitory machine-readable medium of claim 17, wherein the operations further comprise:
generating a hypergraph data object for the hypergraph, wherein the hypergraph data object comprises identifiers for the plurality of signals and event hashes associated with the plurality of computing events for the metadata; and
storing the hypergraph data object in a searchable database accessible by a computing security system.

19. The non-transitory machine-readable medium of claim 18, wherein the operations further comprise:
providing a search system for retrievals of security search result data from the hypergraph data object using a search option including at least one of the identifiers or the event hashes.

20. The non-transitory machine-readable medium of claim 17, wherein the at least one hyperedge comprises at least one relationship between the two or more entities, and wherein each of the at least one relationship are correlated with a hash of an event object for each of the plurality of computing events.
